(19) United States
(12) Patent Application Publication
(10) Pub. No.: US 2007/0274749 A1
(43) Pub. Date: Nov. 29, 2007

(54) Image forming apparatus and image forming method

(75) Inventors: Masato Ogasawara, Katsushika-ku (JP); Kazufumi Ishida, Sunto-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/440,655

(22) Filed: May 24, 2006

(51) Int. Cl. G03G 21/00

(52) U.S. Cl. 399/350

(57) ABSTRACT

In an image forming apparatus of this invention, a cleaning bias of opposite polarity to toner is applied to a conductive cleaning blade, thus enhancing the cleaning performance of the cleaning blade. Thus, even for substantially spherical toner, good cleaning is provided without increasing the pressing force of the cleaning blade to a photoconductive drum. The durability of the photoconductive member and the cleaning blade is improved and maintenance is reduced.

### BACKGROUND OF THE INVENTION

1. Field of the Invention

This invention relates to an image forming apparatus and an image forming method used for a copy machine, printer or the like in which toner remaining on an image carrier is cleaned by a blade.

2. Description of the Related Art

An image forming apparatus such as a copy machine or printer has a cleaning device for toner remaining on a photoconductive member after transfer is finished. As the cleaning device, there is a blade cleaning device that removes the remaining toner by sliding a cleaning blade in contact with the photoconductive member. The blade cleaning device has a compact form, compared with a brush cleaning device using a rotary brush. Also, the blade cleaning device does not require a driving source and has a simply construction.

On the other hand, in the blade cleaning device, if the pressing force of the cleaning blade to the photoconductive member is strong, degradation of the distal end of the cleaning blade or degradation of the surface of the photoconductive member is accelerated. Therefore, it is desired to reduce the pressing force of the cleaning blade to the photoconductive member to the minimum level. However, in the case where the remaining toner on the photoconductive member is spherical toner, which is substantially spherical, if the pressing force of the cleaning blade to the photoconductive member is reduced, the spherical toner may slip out of the distal end of the cleaning blade at the time of cleaning.

Thus, conventionally, JP-A-2003-202786 discloses an image forming apparatus in which the physical properties of the cleaning blade material are prescribed, thus providing satisfactory cleaning without applying an excessive pressing force to a photoconductive member. However, in the case of this image forming apparatus, the reduction in the pressing force of the cleaning blade is not sufficient and it is desired to further reduce wear of the photoconductive member and the cleaning blade and to further improve durability and easiness in maintenance.

Meanwhile, conventionally, U.S. Pat. No. 6,340,515 discloses an image forming apparatus in which a conductive member with a bias applied thereto, the bias being of the same polarity as a toner image on a photoconductive member, is slid in contact with the photoconductive member, thus erasing a transfer memory remaining on the photoconductive member. However, the conductive member of this image forming apparatus is not for cleaning the remaining toner on the photoconductive member.

Thus, in a device that removes remaining toner with a cleaning blade, a cleaning blade that can be more compactly designed is used. Even if the pressing force of the cleaning blade to the photoconductive member is reduced, the substantially spherical toner is cleaned satisfactorily. As a result, an image forming apparatus is desired in which a photoconductive member and a cleaning blade have a longer service life.

### SUMMARY OF THE INVENTION

An aspect of this invention resides in satisfactorily cleaning remaining toner in an image forming apparatus that uses spherical toner even if the pressing force of a miniaturized cleaning blade to an image carrier is reduced, realizing a longer service life of the image carrier and the cleaning blade, and providing reduction in maintenance.

According to an embodiment of this invention, an image forming apparatus includes an image carrier, a toner image forming member that forms a toner image on the image carrier by using toner having a shape factor SF of 100≦SF<140, an elastic and conductive cleaning member that is pressed in contact with the image carrier and rakes up the toner on the image carrier, and a voltage supply member that supplies the cleaning member with a voltage of opposite polarity to charging polarity of the toner.

### BRIEF DESCRIPTION OF THE DRAWINGS

FIG. 1 is a schematic structural view showing a color copy machine according to an embodiment of this invention;

FIG. 2 is a schematic structural view showing a cleaner according to an embodiment of this invention;

FIG. 3A is a graph showing evaluations of cleaning performance of a cleaning blade having repulsive elasticity of 45% according to an embodiment of this invention;

FIG. 3B is a graph showing evaluations of cleaning performance of a cleaning blade having repulsive elasticity of 50% according to an embodiment of this invention;

FIG. 3C is a graph showing evaluations of cleaning performance of a cleaning blade having repulsive elasticity of 60% according to an embodiment of this invention;

FIG. 4A is a graph showing evaluations of cleaning of toner having SF=110 according to an embodiment of this invention;

FIG. 4B is a graph showing evaluations of cleaning of toner having SF=122 according to an embodiment of this invention;

FIG. 4C is a graph showing evaluations of cleaning of toner having SF=133 according to an embodiment of this invention;

FIG. 4D is a graph showing evaluations of cleaning of toner having SF=140 according to an embodiment of this invention;

FIG. 5 is a graph showing evaluations of cleaning of toner having SF=148 as a comparative example to the embodiments of this invention.

### DETAILED DESCRIPTION OF THE EMBODIMENTS

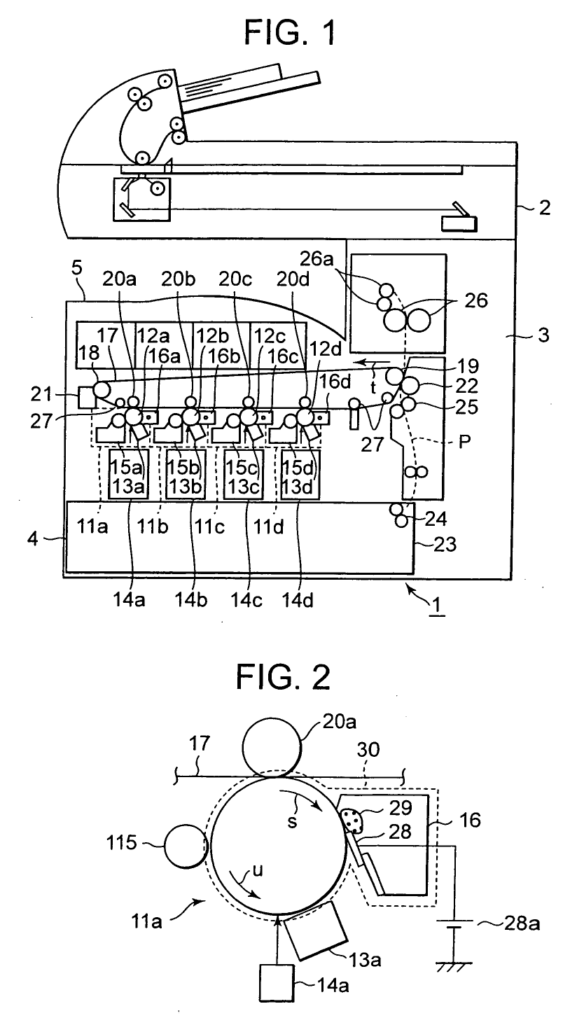

Hereinafter, embodiments of this invention will be described in detail with reference to the attached drawings as examples. FIG. 1 is a schematic structural view showing a four-drum tandem color copy machine 1, which is an embodiment of this invention and is an image forming apparatus. The color copy machine 1 has a scanner unit 2 on the upper side, a printer unit 3, and a paper feeder unit 4. An in-body paper discharge unit 5 is provided between the scanner unit 2 and the printer unit 3.

The printer unit 3 has four sets of process units 11a, 11b, 11c and 11d for yellow (Y), magenta (M), cyan (C) and black (K). The respective process units 11a, 11b, 11c and 11d have photoconductive drums 12a, 12b, 12c and 12d, which are image carriers, and form toner images on the photoconductive drums 12a, 12b, 12c and 12d.

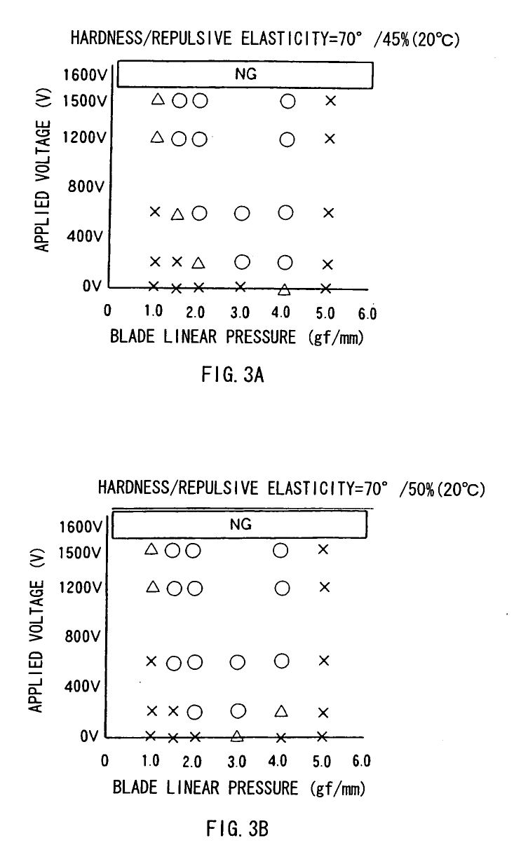

The photoconductive drum 12a of the process unit 11a is cylindrical with a diameter of 30 mm and can rotate forward and backward. While forming a toner image, the photoconductive drum 12 rotate in the direction of arrow s, which is a first direction, shown in FIG. 2. When formation of a toner image is not carried out, the photoconductive drum can rotate in the direction of arrow u, which is a second direction opposite to the direction of arrow s. Around the photoconductive drum 12a, the following elements are arranged along the rotating direction of arrow s.

First, a charger 13a is provided facing the surface of the photoconductive drum 11a. This charger 13a, under constant-current control of minus (−) 1000 μA, generates corona discharge by using a grid of constant-voltage control arranged near and facing the photoconductive drum 12a, and uniformly charges the photoconductive drum 12a at −500 V. The charger may be of a non-contact charging system such as a corona wire. Alternatively, the charger may be of a contact charging system such as a charging roller, charging blade or charging brush that contacts the surface of the photoconductive drum.

Downstream from the charger 13a, an exposure device 14a is provided that exposes the charged photoconductive drum 12a to light and thus forms an electrostatic latent image thereon. The exposure device can use a laser beam or LED or the like.

Downstream from the exposure device 14a, a developing unit 15a is provided that inversely develops the electrostatic latent image formed by the exposure device 14a. A bias voltage of minus 350 V is applied to a developing roller 115 of the developing unit 15a. The developing unit 15a uses a two-component developer made of yellow (Y) spherical toner that has a shape factor of 100≦SF<140 and is substantially spherical, and ferrite carrier. The shape factor SF of the spherical toner in this embodiment is the average value of shape factors (square of circumferential length/projection area). The shape factor SF is calculated by taking a optical microscope image of toner scattered on a slide glass into a LUZEX image analyzer (made by LUZEX) through a video camera and then calculating the (square of circumferential length/projection area) of 50 or more particles of the toner to find the average value.

Also, the average particle size of the spherical toner is approximately 6 to 8 μm. This average particle size is measured by a Coulter multisizer (made by Coulter). The average particle size is expressed by the particle size D50 at the point where the cumulative frequency is 50% with respect to the volumetric average particle size.

The developer may be a one-component developer made of toner without containing any carrier. Moreover, the development system may be either (1) system of contacting the developer layer with the developing roller to the surface of the photoconductive drum, or (2) forming an AC field between the photoconductive drum and the developing roller so as to make the toner fly without contacting the developer layer on the developing roller with the surface of the photoconductive drum.

The charger 13a, the exposure device 14a and the developing unit 15a form a toner image forming member that forms a toner image on the photoconductive drum 12a.

Above the process unit 11a, an endless (seamless) intermediate transfer belt 17 is installed and is abutted against the photoconductive drum 12a. The width of the intermediate transfer belt 17 is substantially equal to the length of the photoconductive drum 12a in the direction orthogonal to the transporting direction, which is the direction of arrow t. The intermediate belt 17 is carried by a driving roller 18, a secondary transfer counter-roller 19, and tension rollers 27. At the position facing the photoconductive drum 12a via the intermediate transfer belt 17, a primary transfer roller 20a is arranged that performs primary transfer of the toner image formed on the photoconductive drum 12a to the intermediate transfer belt 17.

A cleaner 16a is provided downstream from the abutting position of the photoconductive drum 12a and the intermediate transfer belt 17. The cleaner 16a has a cleaning blade 28, which is a cleaning member. The cleaning blade 28 is pressed in contact with the photoconductive drum 12a and rakes up the remaining toner on the photoconductive drum 12a after the transfer. The cleaning blade 28 is formed, for example, by providing polyurethane rubber with conductivity, and it is elastic and conductive. The provision of polyurethane rubber or the like with conductivity is carried out by dispersing carbon and ion-conductive conductive agent into urethane rubber, for example, as disclosed in JP-A-2000-214659. The cleaning blade 28 is supplied with a cleaning bias by a DC power source 28a, which is a voltage supply member. The cleaning bias has the opposite polarity to the charging polarity of the remaining toner on the photoconductive drum 12a.

The cleaner 16a will now be described in detail. The cleaning blade 28 that slides in contact with the photoconductive drum 12a at the time of cleaning is made of an elastic member in order to prevent the risk of damaging the photoconductive drum 12a and improve the tight contact with the photoconductive drum 12a. To enhance the cleaning performance of the cleaning blade 28, it is preferable to set the load of the cleaning blade 28 on the photoconductive drum 12a at a large value. However, to prevent wear of the photoconductive drum 12a and prevent wear and strain tendency of the cleaning blade 28 and thus to provide durability to 50,000 sheets or more, the reduction in the load on the photoconductive drum 12a is necessary.

Therefore, in order to compensate for the reduction in the load of the cleaning blade 28 on the photoconductive drum 12a, the cleaning blade 28 in this embodiment is made conductive and a cleaning bias of the opposite polarity to the charging polarity of the remaining toner on the photoconductive drum 12 is applied to the cleaning blade 28.

Next, the cleaning performance is evaluated with respect to the case where the repulsive elasticity of the cleaning blade 28 is changed and the case where the shape of toner is changed. The cleaning bias applied to the cleaning blade 28 is changed from 0 to +1600 V. The blade linear pressure, which is the load of the cleaning blade 28 on the photoconductive drum 12a, is changed from 0 to 5.0 gf/mm.

The evaluation conditions are as follows.

Photoconductive drum 12a: organic photoconductive material of φ30

Process speed: 150 mm/s

Average particle size: approximately 6.5 μm

Cleaning blade: conductive polyurethane (thickness 2.0 mm, free length 9.0 mm, linear resistance approximately 8.0×10⁶ Ω·cm, hardness 70°)

And, passage of 80,000 sheets of paper is carried out by repeating continuous passage of five sheets, stop, continuous passage of five sheets and so on.

If a cleaning defect occurs during the passage of paper, x is given. If, though good cleaning is provided in the normal process, a cleaning defect occurs when the remaining toner on the photoconductive drum 12a is deliberately increased without performing transfer, Δ is given (no margin, but OK). If good cleaning performance is provided even when the remaining toner on the photoconductive drum 12a is deliberately increased without performing transfer, ο is given (margin exists and OK).

Verification 1: Cleaning Performance Depending on the Difference in Repulsive Elasticity

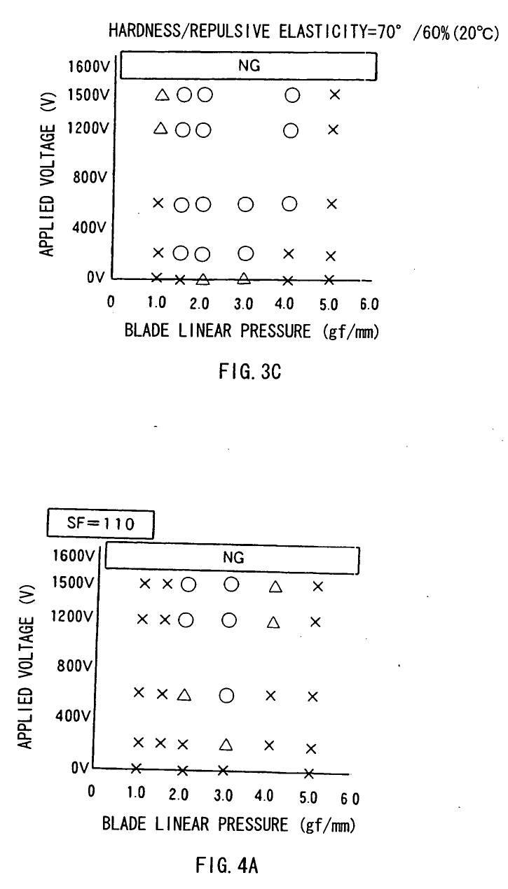

The results of evaluations in the case where the shape factor SF of the toner is approximately 140 and the repulsive elasticity of the cleaning blade 28 (at 20° C.) is 45%, 50% and 60% are shown in FIG. 3A, FIG. 3B and FIG. 3C. (1) When the repulsive elasticity of the cleaning blade 28 is 45%, the result is Δ for the blade linear pressure of 2.0 gf/mm and the cleaning bias of +600 V, as shown in FIG. 3A. (2) When the repulsive elasticity of the cleaning blade 28 is 50%, the result is x for the blade linear pressure of 1.5 gf/mm and the cleaning bias of +200 V, as shown in FIG. 3B. (3) When the repulsive elasticity of the cleaning blade 28 is 60%, the result is all ο if the cleaning bias is applied even if the blade linear pressure is 1.5 gf/mm, and the result is x for the blade linear pressure of 1.0 gf/mm and the cleaning bias of +600 V, as shown in FIG. 3C.

In the case where the blade linear pressure is 5.0 gf/mm, the rubber of the edge part of the cleaning blade 28 fatigues because of the excessive pressing force. Therefore, minute break occurs in the edge part of the cleaning blade 28, causing a cleaning defect. Thus, it is preferable that the blade linear pressure of the cleaning blade 28 is 4 gf/mm or less.

On the other hand, when the blade linear pressure is 1.0 gf/mm, the pressing force is insufficient. Therefore, even if the cleaning bias is applied to the edge part of the cleaning blade 28, sufficient cleaning performance cannot be provided and a cleaning defect occurs. Thus, it is preferable that the blade linear pressure of the cleaning blade 28 is 1.5 gf/mm or less.

When the cleaning bias is +1600 V, the surface potential of the photoconductive drum 12a cannot be sufficiently raised to a negative charging potential in the next charging process, and the surface potential of the photoconductive drum 12a become unstable. Thus, it is preferable that the cleaning bias of the cleaning blade 28 is +1500 V or less.

Verification 2: Cleaning Performance Depending on the Difference in Toner Shape

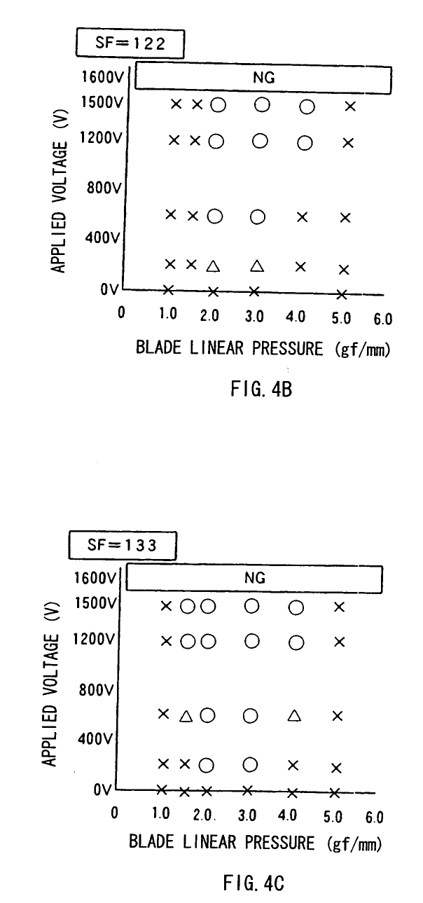

The results of evaluations in the case where repulsive elasticity of the cleaning blade 28 (at 20° C.) is 50% and the shape factor SF of the toner is 110, 122, 133 and 140 are shown in FIG. 4A, FIG. 4B, FIG. 4C and FIG. 4D. (1) When the shape factor SF of the toner is 110, the result is all x for the blade linear pressure of 1.5 gf/mm, irrespective of the cleaning bias, and the result is Δ for the blade linear pressure of 2.0 gf/mm and the cleaning bias of +600 V, as shown in FIG. 4A. (2) When the shape factor SF of the toner is 122, the result is all x for the blade linear pressure of 1.5 gf/mm, irrespective of the cleaning bias, and the result is Δ for the blade linear pressure of 2.0 to 3.0 gf/mm and the cleaning bias of +200 V, as shown in FIG. 4B. (3) When the shape factor SF of the toner is 133, the result is Δ for the blade linear pressure of 1.5 gf/mm and the cleaning bias of +600 V, as shown in FIG. 4C. (4) When the shape factor SF of the toner is 140, the result is ο for the cleaning bias of +600 V, and the result is Δ for the blade linear pressure of 1.0 gf/mm and the cleaning bias of +1200 V, as shown in FIG. 4D.

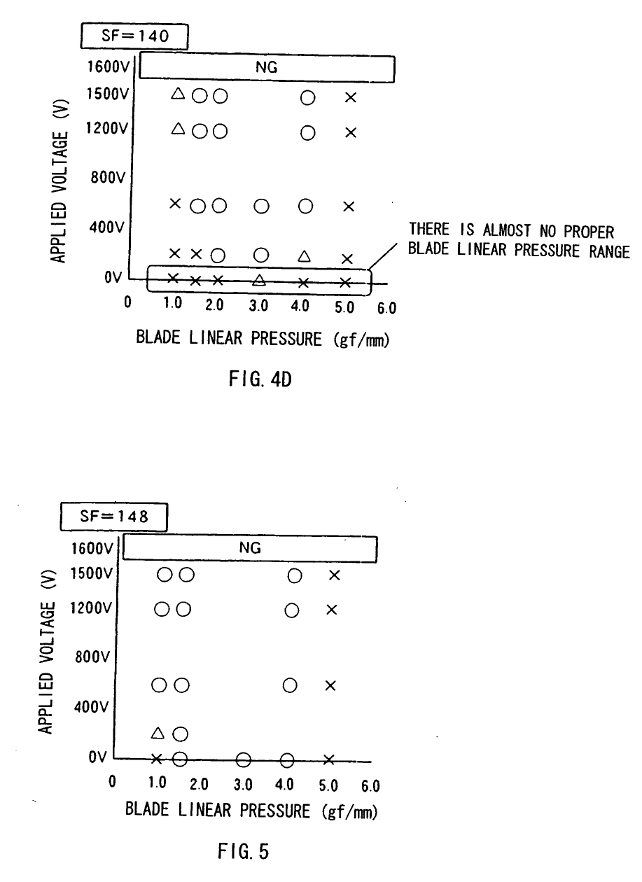

When the blade linear pressure is 5.0 gf/mm, the durability of the photoconductive drum 12a or the cleaning blade is deteriorated, and in either case, a cleaning defect occurs. From the evaluations, as the shape factor SF of the toner is smaller (more proximate to spherical shape), the toner tends to slip out of the cleaning blade 28 more easily and a cleaning defect tends to occur. When the shape factor SF of the toner is 148 as a comparative example, good cleaning can be provided without applying any cleaning bias if the blade linear pressure of the cleaning blade 28 is 1.5 to 4.0 gf/mm, as shown in FIG. 5.

From the above-described Verification 1 and Verification 2, it can be confirmed that, by supplying the cleaning blade 28 with a cleaning bias of the opposite polarity to the charging polarity of the remaining toner, good cleaning performance is provided even if the pressing force of the cleaning blade 28 to the photoconductive drum 12a is reduced to 1.5 to 4.0 gf/mm.

Thus, in this embodiment, when the pressing force of the cleaning blade 28 to the photoconductive drum 12a is reduced to 1.5 to 4.0 gf/mm, a cleaning bias of +1500 V or less is applied to the cleaning blade 28. Thus, the remaining toner having the shape factor SF of 100≦SF<140 is cleaned satisfactorily.

However, for example, when the bias applied to the cleaning blade 28 is 900 V or more, the potential on the surface of the photoconductive drum 12a after passing the cleaning blade 28 is of positive polarity, and the photoconductive drum 12a cannot be easily charged to a desired potential of negative polarity in the charging process by the charger 13a. Also, the photoconductive drum 12a is degraded by the charges of positive polarity and its sensitivity to light changes. The characteristics as described above become conspicuous when the bias applied to the cleaning blade 28 exceeds 1200 V. Therefore, in order to more stabilize the charging potential on the surface of the photoconductive drum 12a in the charging process, it is desirable to set the cleaning bias supplied to the cleaning blade 28 at 1200 V or less.

The cleaner 16a having the cleaning blade 28, and the photoconductive drum 12a, have their lateral sides integrally supported, thus forming a process cartridge 30 indicated by a dotted line in FIG. 2. The process cartridge 30 can be integrally attached to and removed from the main body of the color copy machine 1. The construction of the process cartridge is not limited. It is not limited to integrally supporting the cleaner and the photoconductive drum. It suffices that at least one of the charger, developing unit and cleaner, and the photoconductive drum, are integrally supported, and that the process cartridge can be attached to and removed from the main body of the image forming apparatus. For example, a process cartridge in which all of charger, developing unit and cleaner around photoconductive drum are integrated, can be made attachable to and removable from the main body of the image forming apparatus totally integrally, or any other arbitrary construction may be used.

Downstream from the process unit 11a on the intermediate transfer belt 17, the process units 11b, 11c and 11d are further arranged along the intermediate transfer belt 17. Each of the process units 11b, 11c and 11d has a construction similar to the process unit 11a. That is, the photoconductive drums 12b, 12c and 12d are provided substantially at the center of the respective process units 11b, 11c and 11d.

Around the respective photoconductive drums 12b, 12c and 12d, chargers 13b, 13c and 13d are provided. Also the construction in which developing units 15b, 15c and 15d, and cleaners 16b, 16cand 16d are provided downstream from the chargers, is similar to the process unit 11a. However, the developers housed in the developing units 15b, 15c and 15d are different. The developing unit 15b houses a developer having magenta (M) spherical toner. The developing unit 15c houses a developer having cyan (C) spherical toner. The developing unit 15d houses a developer having black (K) spherical toner.

At the positions facing the respective process units 11b, 11c and 11d via the intermediate transfer belt 17, primary transfer rollers 20b, 20c and 20d for performing primary transfer of toner images formed on the photoconductive drums 12b, 12c and 12d to the intermediate transfer belt 17 are arranged. That is, the primary transfer rollers 20 are provided with their back sides contacting the intermediate transfer belt 17 above the corresponding photoconductive drums, and face the process cartridges via the intermediate transfer belt 17. Primary transfer biases of +1000 V, +1200 V, +1400 V and +1600 V are sequentially applied to the primary transfer rollers 12a, 12b, 12c and 20d. Thus, the toner images on the photoconductive drums 12a, 12b, 12c and 20d are primary-transferred to the intermediate transfer belt 17.

Meanwhile, in the paper feeder unit 4 in the lower part of the color copy machine 1, a pickup roller 24 for taking out paper P one by one from a paper feed cassette 23. The paper P taken out from the paper feed cassette 23 by the pickup roller 24 is supplied to a secondary transfer part by a pair of registration rollers 25 at predetermined timing. In the secondary transfer part, a secondary transfer roller 22 and a secondary transfer counter-roller 19 face each other, with the intermediate belt held between them. A predetermined secondary bias is applied to the secondary transfer part by the secondary transfer counter-roller 19. Thus, in the secondary transfer part, a transfer field is formed between the intermediate transfer belt 17 and the secondary transfer counter-roller 19. By this transfer field, the toner image on the intermediate transfer belt 17 is secondary-transferred onto the sheet paper P passing between the intermediate transfer belt 17 and the secondary transfer roller 22. Downstream from the secondary transfer part on the intermediate transfer belt 17, a belt cleaner 21 for removing remaining toner is provided.

Downstream from the secondary transfer roller 27 along the transporting direction of the sheet paper P, there is provided a fixing unit 26 that fixes the toner image to the sheet paper, and a paper discharge roller 26a that ejects the sheet paper P on which fixation is done by this fixing unit 26, to the in-body paper discharge 5. The fixing unit 26 may employ either (1) a system in which a heating source is provided within a roller and the roller is directly contacted with the sheet paper, or (2) a system in which the paper is heated via a movable film-like member, or the like.

Next, the operation will be described. As the image forming process is started, the photoconductive drums 12a, 12b, 12c and 12d are rotated in the direction of arrow s in the respective process units 11a, 11b, 11c and 11d. In the yellow (Y) process unit 11a, the charger 13a uniformly charges the photoconductive drum 12a at approximately −500 V. Next, the exposure device 14a irradiates the photoconductive drum 12a with light corresponding to image information to be recorded, and thus forms an electrostatic latent image. The developing unit 15a inversely develops the electrostatic latent image on the photoconductive drum 12a by the developing roller 115 to which a development bias of −350 V is applied, and thus forms a toner image on the photoconductive drum 12a.

The toner image on the photoconductive drum 12a contacts the intermediate transfer belt 17 turned in the direction of arrow t, and is primary-transferred to the intermediate transfer belt 17 by the primary transfer roller 20a to which a bias voltage of approximately +1000 V is applied. After the primary transfer ends, the remaining toner on the photoconductive drum 12a is removed by the cleaning blade 28 to which a cleaning bias is applied in the cleaner 16, and the next image forming process is enabled. The cleaning bias applied to the cleaning blade 28 can be within a range that enables good cleaning of the remaining toner on the photoconductive drum 12a. However, to provide good charging performance in the next image forming process, the cleaning bias is preferably +1500 V or less, and more preferably, 1200 V or less.

Similar to this yellow (Y) toner image forming process, the toner image forming process is carried out in the magenta (M), cyan (C) and black (K) image forming units 11a, 11c and 11d. The toner images formed on the respective photoconductive drums 12b, 12c and 12d are sequentially multiple-transferred at the same position where the yellow (Y) toner image has been formed on the intermediate transfer belt 17. In this case, primary transfer biases of +1200 V, +1400 V and +1600 V are sequentially applied to the magenta (M), cyan (C) and black (K) primary transfer rollers 12b, 12c and 20d.

After the primary transfer ends, the remaining toner on the respective photoconductive drums 12b, 12c and 12d is removed by the cleaning blades 28 to which a cleaning bias is applied in the respective cleaners 16b, 16c and 16d, and the next image forming process is enabled.

After this, the multiple-color toner images of yellow (Y), magenta (M), cyan (C) and black (K), which have been multiple-transferred onto the intermediate transfer belt 10, are supplied to the secondary transfer part in which the secondary transfer roller 22 and the secondary transfer counter-roller 19 face each other via the intermediate belt. In this case, the paper P taken out from the paper feed cassette 23 by the pickup roller 24 is transported to the secondary transfer part synchronously with the multiple-color toner images.

In the secondary transfer part, the multiple-color toner images on the intermediate transfer belt 17 are transferred at a time to the paper P by a predetermined secondary transfer bias from the secondary transfer counter-roller 19. The multiple-color toner images, thus transferred at a time, are fixed onto the paper P by the fixing unit 26, thus forming a color image. The paper P on which fixation is completed is ejected to the in-body paper discharge unit 5. Meanwhile, the remaining toner on the intermediate transfer belt 17 is cleaned by the belt cleaner 21 after the secondary transfer ends.

In the image forming process, negatively charged toner 29 is electrostatically captured and deposited at the edge of the cleaning blade 28 to which a bias of positive polarity is applied. This leads to deterioration in the cleaning performance of the cleaning blade 28. Such a phenomenon tends to occur particularly when a cleaning bias of +700 V or more is applied to the cleaning blade 28.

Thus, in this embodiment, after the image forming process ends, the rotation of the photoconductive drum 12a is stopped and then the photoconductive drum 12a is rotated in the direction of arrow u, which is opposite to the direction of arrow s. The amount of rotation is approximately 5 to 10 mm. After it is rotated backward approximately 5 to 10 mm, the photoconductive drum 12a is stopped again and stands by for the next image forming process. By this backward rotation of the photoconductive drum 12a in the direction of arrow u, the toner deposited at the edge of the cleaning blade 28 is broken. By this, the toner is easily removed from the edge of the cleaning blade 28. Thus, the edge of the cleaning blade 28 constantly maintains good cleaning performance.

According to this embodiment, a cleaning bias of opposite polarity to the remaining toner on the photoconductive drum 12a is applied to the cleaning blade 28. This enhances the cleaning performance of the cleaning blade 28. Therefore, even for spherical toner having a shape factor SF of 100≦SF<140, the pressing force of the cleaning blade 28 to the photoconductive drum 12a need not be increased. Good cleaning performance is provided even if the blade linear pressure of the cleaning blade 28 to the photoconductive drum 12a is reduced to 1.5 to 4.0 gf/mm. Therefore, durability of the cleaning blade 28 and the photoconductive drum 12a is provided. Thus, even for spherical toner, cleaning by the compact cleaning blade 28 is realized. Also, reduction in maintenance is realized by the improvement in the durability of the photoconductive drum 12a and the cleaning blade 28. Moreover, according to this embodiment, after the image forming process ends, the photoconductive drum 12a is rotated backward to remove the toner deposited at the edge of the cleaning blade 28, thus enhancing the cleaning performance.

It should be noted that this invention is not limited to the above embodiment and that various modifications can be made within the scope of this invention. For example, the material of the conductive cleaning member is not limited. Also, the charging polarity of the toner is arbitrary, and a bias of the opposite polarity is applied to the cleaning member in accordance with the charging polarity of the toner. Moreover, with respect to the construction of the image forming apparatus, a monochrome-type image forming apparatus may be used.

1. An image forming apparatus comprising:
an image carrier;
a toner image forming member that forms a toner image on the image carrier by using toner having a shape factor SF of 100≦SF<140;
an elastic and conductive cleaning member that is pressed in contact with the image carrier and rakes up the toner on the image carrier; and
a voltage supply member that supplies the cleaning member with a voltage of opposite polarity to charging polarity of the toner,
wherein the image carrier rotates in a first direction at the time of forming the toner image by the toner forming member and the time of raking up residual toner on the image carrier by the elastic and conductive cleaning member, and the image carrier rotates by a prescribed amount of rotation in a second direction opposite to the first direction after an image forming process ends and when the toner image is not being formed by the toner forming member in order to remove toner deposited at the elastic and conductive cleaning member.

2. The image forming apparatus as claimed in claim 1, wherein the voltage supply member supplies a voltage of 1500 V or less.

3. The image forming apparatus as claimed in claim 2, wherein the voltage supply member supplies a voltage of 1200 V or less.

4. The image forming apparatus as claimed in claim 1, wherein pressing force of the cleaning member to the image carrier is 1.5 to 4.0 gf/mm.

5. (canceled)

6. (canceled)

7. (canceled)

8. The image forming apparatus as claimed in claim 1, wherein at least the image carrier and the cleaning member form a process cartridge that can be integrally attached to and removed from the image forming apparatus.

9. An image forming apparatus comprising:
image carrier means for supporting a toner image;
toner image forming means for forming a toner image on the image carrier means by using toner having a shape factor SF of 100≦SF<140;
elastic and conductive cleaning means for being pressed in contact with the image carrier means and raking up the toner on the image carrier means; and
voltage supply means for supplying the cleaning means with a voltage of opposite polarity to charging polarity of the toner,
wherein the image carrier rotates in a first direction at the time of forming the toner image by the toner forming member and the time of raking up residual toner on the image carrier by the elastic and conductive cleaning member, and the image carrier rotates by a prescribed amount of rotation in a second direction opposite to the first direction after an image forming process ends and when the toner image is not being formed by the toner forming member in order to remove toner deposited at the elastic and conductive cleaning member.

10. The image forming apparatus as claimed in claim 9, wherein the voltage supply means supplies a voltage of 1500 V or less.

11. The image forming apparatus as claimed in claim 10, wherein the voltage supply means supplies a voltage of 1200 V or less.

12. The image forming apparatus as claimed in claim 9, wherein pressing force of the cleaning means to the image carrier means is 1.5 to 4.0 gf/mm.

13. (canceled)

14. (canceled)

15. An image forming method comprising:
forming a toner image on an image carrier by using toner having a shape factor SF of 100≦SF<140;
transferring the toner image formed on the image carrier to a transfer target member;
raking up the toner remaining on the image carrier after transfer and the image carrier rotates in a first direction, by an elastic and conductive cleaning member that is supplied with a voltage of opposite polarity to charging polarity of the toner; and
removing the toner deposited at the elastic and conductive cleaning member after the image carrier stops the rotation in a first direction and when the toner image is not being formed by the toner forming member, by rotating a prescribed amount of rotation in a second direction opposite to the first direction.

16. The image forming method as claimed in claim 15, wherein the voltage supplied to the cleaning member at the time of raking up is 1500 V or less.

17. The image forming method as claimed in claim 16, wherein the voltage supplied to the cleaning member at the time of raking up is 1200 V or less.

18. The image forming method as claimed in claim 15, wherein at the time of raking up, the cleaning member contacts the image carrier with a pressing force of 1.5 to 4.0 gf/mm.

19. (canceled)

20. (canceled)
